(19) United States
(12) Patent Application Publication
(10) Pub. No.: US 2023/0364614 A1
(43) Pub. Date: Nov. 16, 2023

(54) MICROFLUIDIC PROBES

(71) Applicants: Bio-Rad Laboratories, Inc., Hercules, CA (US); Bio-Rad Europe GmbH, Basel (CH)

(72) Inventors: Iago Pereiro Pereiro, Zurich (CH); Anna Fomitcheva Khartchenko, Zurich (CH); Robert Dean Lovchik, Schönenberg (CH); Govind Kaigala, Rüschlikon (CH); Lorenzo Franco Teodoro Petrini, Ticino (CH); Anel Zulji, Wildegg (CH); Frédéric M. Buffière, Pessac (FR); Johann Guégan, Rueil-Malmaison (FR); Eliane Rivalin, Villennes-sur-Seine (FR); Sylvie Villard-Saussine, Clamart (FR)

(21) Appl. No.: 18/227,212

(22) Filed: Jul. 27, 2023

Related U.S. Application Data
(63) Continuation of application No. PCT/US2022/070456, filed on Feb. 1, 2022.
(60) Provisional application No. 63/144,244, filed on Feb. 1, 2021.

(51) Int. Cl. B01L 3/00

(52) U.S. Cl. CPC B01L 3/502784; B01L 3/502746; B01L 2200/027; B01L 2300/0832; B01L 2400/0487; B01L 2400/0622

(57) ABSTRACT

In one implementation, a microfluidic probe has a non-planar processing surface and an inlet aperture. The shape of the surface may be selected to produce a specific velocity gradient profile across a surface onto which fluid is deposited using the microfluidic probe, for example a constant velocity gradient or a velocity gradient that decreases linearly with distance from the inlet aperture. The microfluidic probe may define and overflow notch in a perimeter edge of the processing surface.

### CROSS-REFERENCE TO RELATED APPLICATIONS

This application is a continuation application of International Patent Application No. PCT/US2022/070456 entitled “MICROFLUIDIC PROBES,” filed on Feb. 1, 2022, which claims priority to U.S. Provisional Application No. 63/144,244 entitled “MICROFLUIDIC PROBES,” filed on Feb. 1, 2021, each of which are herein incorporated by reference in their entirety for all purposes.

### BACKGROUND OF THE INVENTION

The present disclosure relates generally to microfluidic probes.

A microfluidic probe is a non-contact microfluidic system combining concepts of hydrodynamic flow confinement (HFC) and scanning probes for yielding a dynamic microfluidic device which may eliminate the need for performing analyses within closed conduits. Typical probes operate under the well-known Hele-Shaw cell approximation, wherein a quasi-2D Stokes flow is generated between two parallel generally flat surfaces -i.e., plates - separated by an arbitrarily small gap working in a microfluidic dipole and microfluidic quadrupole configuration. Generally, the method may be used for applications such as patterning protein arrays on flat surfaces, mammalian cell stimulations and manipulations, localized perfusion of tissue slices as well as generating floating concentration gradients. Microfluidic probes have been proposed as a tissue lithography tool, and may allow prospective studies of formalin-fixed, paraffin-embedded tissue sections. The technique has also been used in the microfluidic quadrupole configuration, as a tool for advanced cell chemotaxis studies, wherein it may allow studying cellular dynamics during migration in response to moving concentration gradients.

### BRIEF SUMMARY

According to one aspect, a microfluidic probe head comprises a body having a proximal end and a distal end, a processing surface at the distal end, and an injection aperture in the processing surface, wherein the processing surface is non-planar.

### BRIEF DESCRIPTION OF THE DRAWINGS

FIG. 1 illustrates a lower oblique partial view of a simple form of microfluidic probe head.

FIG. 2 shows an orthogonal section view of the microfluidic probe head of FIG. 1, held against a plate.

FIG. 3 shows the flow of fluid through a portion of a gap between the microfluidic probe head and plate of FIG. 2.

FIG. 4 illustrates a flow velocity gradient for a relatively slow fluid flow, and a resulting depletion zone.

FIG. 5 illustrates a flow velocity gradient for a relatively faster fluid flow, and a resulting depletion zone.

FIG. 6 illustrates the variation of flow velocity gradient with radius, for fluid deposited with the microfluidic probe head of FIG. 1.

FIG. 7 shows the variation of ligand capture with radius, for fluid deposited with the microfluidic probe head of FIG. 1.

FIG. 8 shows a microfluidic probe having tapered geometry, in accordance with embodiments of the invention.

FIG. 9 shows the microfluidic probe of FIG. 8 in cross section, and flow profiles at different locations under the microfluidic probe, in accordance with embodiments of the invention.

FIG. 10 illustrates an ideal shape of a processing surface of the microfluidic probe of FIG. 8, for constant surface velocity gradient in accordance with embodiments of the invention, and the shape of a constant-gap microfluidic probe.

FIG. 11 shows the results of a finite element modeling (FEM) simulation of the two probes illustrated in FIG. 10.

FIG. 12 illustrates a microfluidic probe having a processing surface with tapered geometry, and also including aspiration apertures surrounding a central inlet aperture, in accordance with embodiments of the invention.

FIG. 13 illustrates a microfluidic probe having a processing surface with tapered geometry, and also including an aspiration ring surrounding a central inlet aperture, in accordance with embodiments of the invention.

FIG. 14 shows the performance of a microfluidic probe such as the microfluidic probe of FIG. 13, as viewed from below though a transparent plate.

FIG. 15 shows three different processing surface shapes and velocity gradient profiles, in accordance with embodiments of the invention.

FIG. 16 defines a slope m, which is the desired slope of the linear reduction of the velocity gradient with radial distance for a microfluidic probe in accordance with other embodiments of the invention.

FIG. 17 illustrates a cross section of a microfluidic probe having a processing surface with discontinuities of taper between different annular regions, in accordance with embodiments of the invention.

FIG. 18 shows a flow velocity profile for the microfluidic probe of FIG. 17.

FIG. 19 shows a top view of an area processed by the microfluidic probe of FIG. 17.

FIG. 20 shows section and top views of a microfluidic probe such as microfluidic probe of FIG. 8, being used to initially wet a surface, in accordance with embodiments of the invention.

FIG. 21 shows top and section views of a microfluidic probe having a constant gap being used to initially wet a surface.

FIG. 22 illustrates the movement of bubbles in the gap of a microfluidic probe in accordance with embodiments of the invention.

FIG. 23 illustrates the effect of tapered geometry combined with a channel path of a microfluidic device, in accordance with embodiments of the invention.

FIG. 24 illustrates the velocity flow gradient in a straight, closed flow channel having a rectangular cross section and longitudinal symmetry.

FIG. 25 illustrates the velocity flow gradient in a straight, closed flow channel having rounded corners, in accordance with embodiments of the invention.

FIG. 26 illustrates a flow channel that varies in width, in accordance with embodiments of the invention.

FIG. 27 illustrates a flow channel that varies in height, in accordance with embodiments of the invention.

FIG. 28 illustrates experimental results of the use of a microfluidic probe in accordance with embodiments of the invention.

FIG. 29 illustrates the difficulty of filling a flat chamber from a dry state through a central aperture.

FIG. 30 illustrates how a microfluidic probe having tapered geometry may facilitate filling a probe gap from a dry state, in accordance with embodiments of the invention.

FIG. 31 shows the filling process of FIG. 30 from top and side views.

FIG. 32 illustrates a pinning effect in accordance with embodiments of the invention.

FIG. 33 illustrates the pinning of a fluid at a sharp edge.

FIG. 34 shows a lower perspective view of microfluidic probe, including a tapered processing surface, an aspiration groove, and a notch, in accordance with embodiments of the invention.

FIG. 35 shows a cross section of the microfluidic probe of FIG. 34, in accordance with embodiments of the invention.

FIG. 36 shows a solid model of the spaces within the microfluidic probe of FIG. 34 for receiving fluids.

FIG. 37 shows fluid flow within the microfluidic probe of FIG. 34, in accordance with embodiments of the invention.

FIG. 38 shows fluid flow within the microfluidic probe of FIG. 34, in accordance with embodiments of the invention.

FIG. 39 shows bottom views of probes of other shapes, in accordance with other embodiments of the invention.

FIG. 40 shows the filling of the chamber from an initial dry state in an experimental result, in accordance with embodiments of the invention.

FIGS. 41A-41F illustrate an example process in accordance with embodiments of the invention.

### DETAILED DESCRIPTION OF THE INVENTION

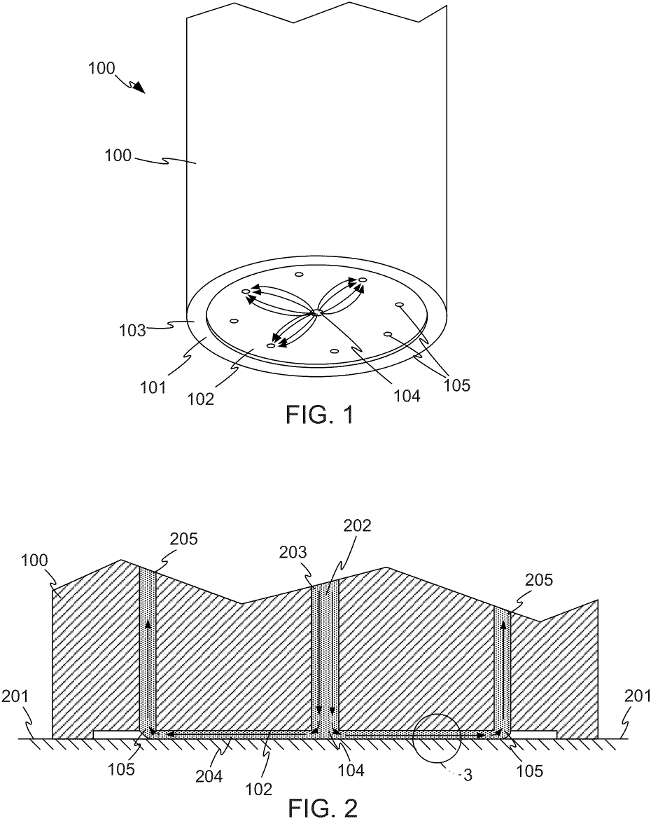

FIG. 1 illustrates a lower oblique partial view of a simple form of microfluidic probe head 100. Microfluidic probe head 100 has a distal end 101, and a proximal end opposite the distal end (out of the view of FIG. 1). Microfluidic probe head 100 also includes a processing surface 102, recessed from distal end 101, leaving an annular surface 103 surrounding processing surface 102. In use, annular surface 103 may be held against a flat plate, and fluid may be dispensed from a central aperture 104. The fluid spreads outward from central aperture 104, coating the plate, and flows toward aspiration apertures 105. Excess fluid may be pulled away from the plate by a partial vacuum applied externally to aspiration apertures 105. Only some of the fluid flows are shown in FIG. 1.

FIG. 2 shows an orthogonal section view of microfluidic probe head 100, held against a plate 201. Fluid 202 flows down central channel 203 to central aperture 104, outward through gap 204 between plate 201 and processing surface 102, through aspiration apertures 105, and upward through aspiration channels 205.

It will be recognized that for a constant volumetric flow of fluid 202, the average velocity of the fluid through gap 204 is higher near central aperture 104 than at aspiration apertures 105. This is because the frontal area of the flow grows as the square of the distance from the central aperture 104 outward. In addition, other aspects of the flow vary with radial distance.

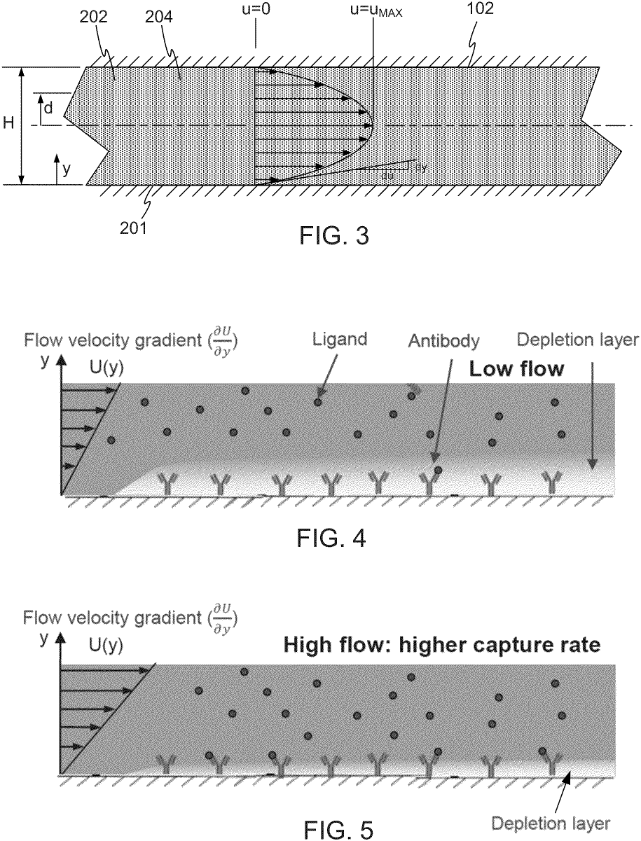

FIG. 3 shows the flow of fluid 202 through a portion of the gap 204. As is well known, under laminar flow conditions, a fluid flowing through a confined channel tends to develop a parabolic flow profile, with the flow velocity at the boundaries of the space (processing surface 102 and plate 201 in this example) being zero, and the maximum flow velocity u_{MAX} being at the middle of the channel. At other points, the velocity is given by

$${\text{u=u}}_{\text{MAX}} * \left(\text{1-} {\left(2 \text{d} / \text{H}\right)}^{2}\right)$$

The value of u_{MAX} depends on several factors, including the thickness H of the channel, the viscosity of the fluid, and pressure gradient in the fluid in the direction of flow.

For the purposes of this disclosure, the velocity gradient ∂u/∂y at the surface of plate 201 is of particular interest.

For example, in one application, fluid 202 may carry ligands and plate 201 may have attached receptors such as antibodies for capturing the ligands. Passing fluid 202 over plate 201 and then measuring the capture of ligands may indicate the concentration of the ligands. In some applications, such a technique may be used to detect the existence of ligands in fluid 202, for disease diagnosis or other purposes.

The kinetics of the ligand-receptor capture process depend on the rate of the chemical reaction (affinity of the binding) and the mass transport rate of the ligand to the surface. Both rates are usually compared with the Damkohler number (Da). The Damkohler number Da may be expressed as

$$\text{Da} = \text{reaction rate} / \text{mass transfer rate} .$$

If Da <<1 the chemical reaction limits the kinetics and mass transport plays no significant role. However, for biological systems often Da >> 1 because the mass transport rate is limited by low diffusion coefficients of biomolecules (ex. proteins). The chemical reaction rate being higher than the mass transport rate, a depletion zone (zone with low concentration of ligands) forms on top of the receptors, slowing the kinetics. The size of this depletion zone is inversely proportional to the vertical flow velocity gradient above the surface, as shown in FIGS. 4 and 5.

In FIG. 4, the velocity gradient ∂u/∂y is relatively small, and the depletion layer is accordingly relatively thick. In FIG. 5, the velocity gradient ∂u/∂y is larger than in FIG. 4, and the depletion layer is thinner than in FIG. 4.

Because the kinetics of the reaction are directly dependent on the flow velocity conditions at the surface, in most applications these flow-velocity conditions should be as uniform as possible. This may be of particular concern in using a microfluidic probe such as microfluidic probe 100, because the flow conditions vary dramatically with radial distance from central aperture 104.

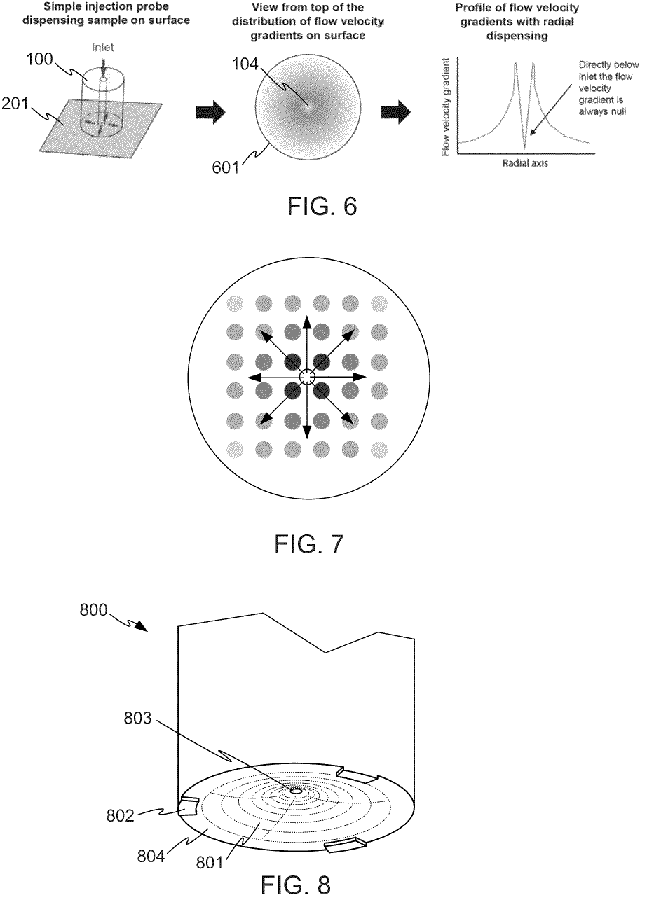

FIG. 6 illustrates this variation. As fluid is deposited on plate 201 microfluidic probe 100, the flow velocity gradient decreases with radial distance. As is shown qualitatively in the center panel of FIG. 6, the flow velocity gradient is higher near central aperture 104 of microfluidic probe 100 (shown by darker shading), and reduces toward the perimeter 601 of microfluidic probe 100 (shown by increasingly lighter shading). The right panel of FIG. 6 shows the flow velocity gradient graphically. As is apparent, once the effects of central aperture 104 are escaped, the flow velocity gradient decreases dramatically with radial distance.

This kind or radial flow distribution is very poorly adapted to the mass transport of microarrays of spots, since the decay of the flow velocity gradient is exponential from the inlet area, with no plateaus (no possibility of shrinking the array to a specific area). The resulting capture of a ligand by equivalent spots of a microarray will vary as shown in FIG. 7. The center spots will see a higher flow velocity gradient and will be more kinetically favored, capturing a higher number of ligands, as indicated by darker shading.

According to some embodiments of the invention, a microfluidic probe has a processing surface that is non-planar, and forms a varying gap from the processing surface to a plate on which the distal end of the microfluidic probe is placed. In some preferred embodiments, the distance from the processing surface to the distal end diminishes with radial distance from the injection aperture. This arrangement may also be referred to as a “tapered” processing surface geometry. For example, FIG. 8 shows a microfluidic probe 800 having a roughly cone-shaped processing surface 801, in accordance with embodiments of the invention. At the central aperture 803, processing surface 801 is recessed farther from distal end 802 than at the periphery 804 of the processing surface.

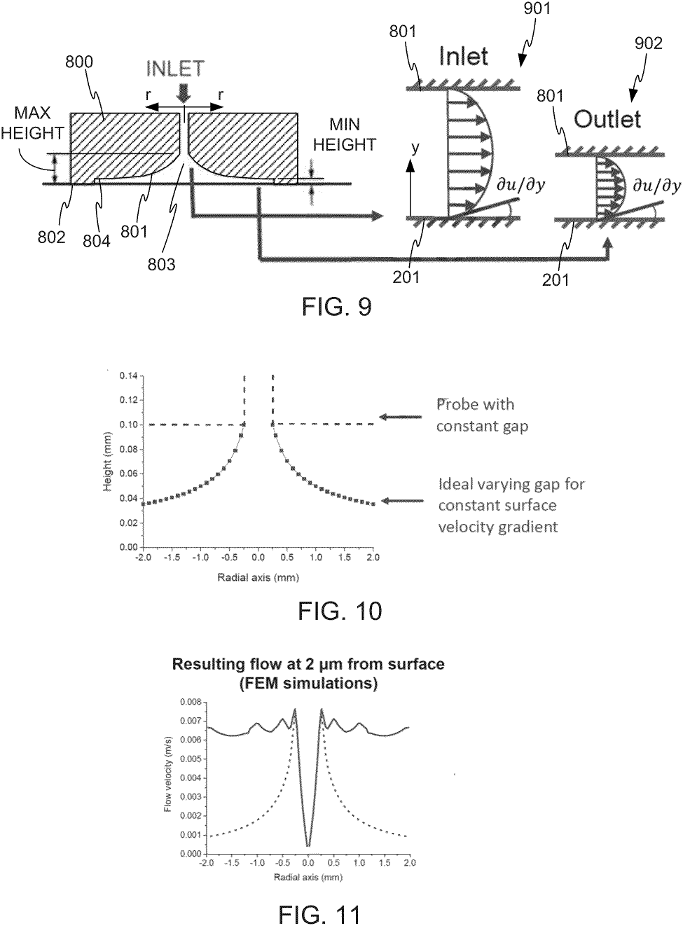

FIG. 9 shows microfluidic probe 800 in cross section, with central aperture 803 being higher than the periphery 804 of processing surface 801. In this example, processing surface 801 is concave upward (away from distal end 802), although the cone shape of the surface opens downward. That is, the slope of processing surface 801 in relation to plate 201 is steeper near the central aperture 803 than at periphery 804.

Also shown in FIG. 9 are flow profiles 901 and 902, taken near central aperture 803 and at the periphery 804 respectively of processing surface 801. In this example, the shape of processing surface 801 is such that the velocity gradient ∂u/∂y remains constant as a function of radial distance from central aperture 803.

Notably, keeping a constant velocity gradient ∂u/∂y close to the surfaces as in this example is different from keeping a constant average velocity in the microfluidic channel. In other embodiments, a processing surface shape may be specified to maintain a constant average velocity, which may be useful for other purposes.

FIG. 10 shows an ideal shape for processing surface 801 having an inlet surface-probe distance of 100 µm and an inlet of r = 250 µm, and compares the shape with a constant-gap probe such as microfluidic probe 100, in accordance with embodiments of the invention. FIG. 11 shows the results of a finite element modeling (FEM) simulation of the two probes illustrated in FIG. 10. The flow velocity at 2 µm from the plate surface is plotted, which is a good indicator of the velocity gradient at the plate surface. As can be seen, the flow velocity gradient at the plate surface is nearly constant for microfluidic probe 800 having a varying gap, while the flow velocity gradient varies dramatically for the constant-gap probe.

The shape of processing surface 801 can be analytically determined. As is well known, the velocity profile of a fluid flowing between two flat surfaces is parabolic:

$$u = \frac{3 Q y}{π \text{} {H}^{3} r} \left(H - y\right) = \frac{3 Q}{π \text{} {H}^{3} r} \left(H y - {y}^{2}\right) \qquad \text{(1)}$$

Where Q is the volumetric flow rate of the fluid, r is the radial distance from the inlet, and H is the gap between the surface and the probe. Differentiating with respect to y gives:

$$\frac{\partial u}{\partial y} = \frac{3 Q}{π \text{} {H}^{3} r} \left(H - 2 y\right) \qquad \text{(2)}$$

Setting y=0 gives

$$\frac{\partial u}{\partial y} \left(y = 0\right) = \frac{3 Q}{π \text{} {H}^{3} r} H = \frac{3 Q}{π \text{} {H}^{2} r} \qquad \text{(3)}$$

In order for this quantity to be constant for a constant flow rate Q, H²r must be constant. Setting Hᵢ as the height at the inlet aperture, and rᵢ as the radius of the inlet aperture, then for any arbitrary position r,

$$r {H}^{2} = {r}_{i} {H}_{i}^{2} \qquad \text{(4)}$$

solving for H gives:

$$H = {H}_{i} \sqrt{\frac{{r}_{i}}{r}} \qquad \text{(5)}$$

A microfluidic probe with a non-planar processing surface may be combined with aspiration rings or radially distributed aspiration channels, which may result in a radial hydrodynamic flow confinement that operates at constant surface flow gradients in its whole footprint. Such a microfluidic probe may be operated on surfaces submerged in immersion liquid.

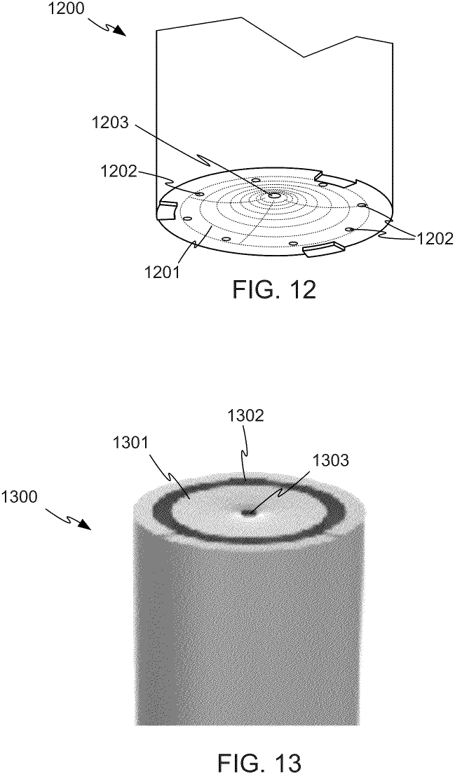

FIG. 12 illustrates a microfluidic probe 1200 having a processing surface 1201 with tapered geometry, and also including aspiration apertures 1202 surrounding central inlet aperture 1203.

In other embodiments, an aspiration ring or groove may surround the processing surface. For example, FIG. 13 illustrates a microfluidic probe 1300 having a processing surface 1301 with tapered geometry, and also including an aspiration ring 1302 surrounding central inlet aperture 1303.

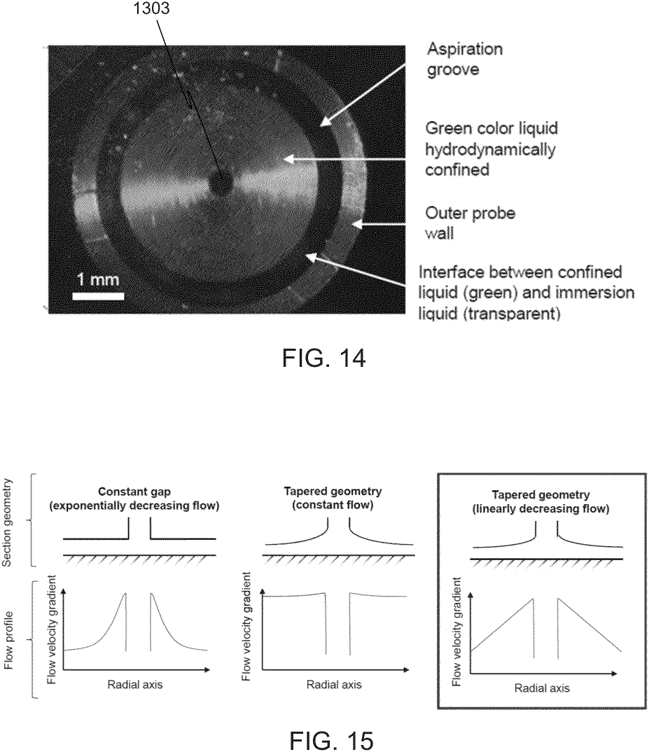

FIG. 14 shows the performance of a microfluidic probe such as microfluidic probe 1300, as viewed from below though a transparent plate. The microfluidic probe is immersed in a transparent liquid, and dispenses a green liquid on to the top of the transparent plate, through central inlet aperture 1303. The dispensed fluid flows outward from central inlet aperture 1303, and is aspirated away from the transparent plate through the aspiration groove. Because the flow confinement acts locally, no contamination with the surrounding immersion liquid takes place. As a consequence, the probe can scan different areas, which will always see an equivalent flow velocity gradient. An array of spots could be scanned instead of being fully addressed with a large confinement.

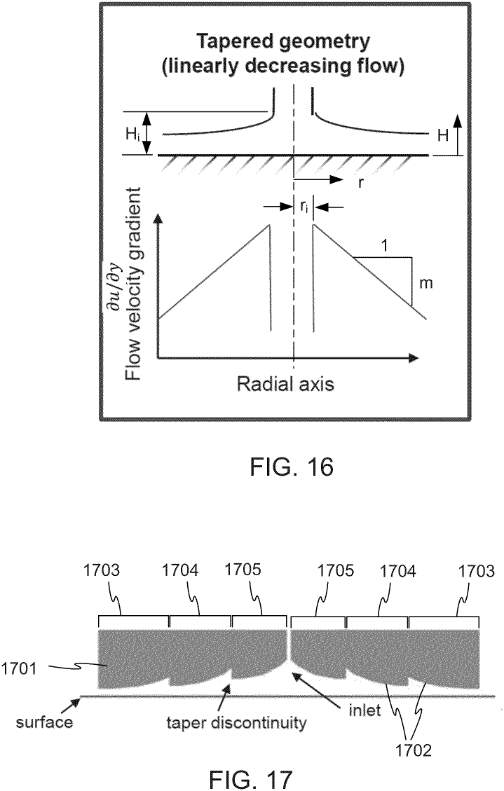

In some applications, particularly for microarrays of spots, it may be of interest to explore the kinetics of a chemical system by exposing different spots to different controlled surface flow velocity gradients. In this case, the height-varying designs can offer defined gradually changing flow conditions in different areas, instead of a perfect uniformity of flow conditions. For example, FIG. 15 shows three different processing surface shapes and velocity gradient profiles. The leftmost profile indicates the performance of a constant-gap microfluidic probe, such as microfluidic probe 100. The center profile indicates the performance of a microfluidic probe such as microfluidic probe 800, having a processing surface shaped to maintain a constant velocity gradient as a function of radial distance. The rightmost profile indicates the performance of a microfluidic probe having a processing surface shaped to provide a velocity gradient that decreases linearly with radial distance. The shape of the processing surface may be determined using a procedure similar to that given above for the constant-velocity-gradient microfluidic probe 800. For example, FIG. 16 defines a slope m, which is the desired slope of the linear reduction of the velocity gradient with radial distance. The parameters H, Hᵢ, r, and rᵢ are as defined above. Equation (3) above still holds. That is

$$\frac{\partial u}{\partial y} \left(y = 0\right) = \frac{3 Q}{π \text{} {H}^{3} r} H = \frac{3 Q}{π \text{} {H}^{2} r} \qquad \text{(3)}$$

However, for a linearly decreasing velocity gradient,

$$\frac{3 Q}{π \text{} {H}^{2} r} = \frac{3 Q}{π \text{} {H}_{i}^{2} {r}_{i}} \left(1 - m \left(r - {r}_{i}\right)\right) \qquad \text{(6)}$$

Solving for H in terms of r gives:

$$H = {H}_{i} \sqrt{\frac{{r}_{i}}{r \left(1 - m \left(r - {r}_{i}\right)\right)}} \qquad \text{(7)}$$

Note that for m=0, equation (7) reduces to equation (5) above.

The processing surface shapes needed to achieve other velocity profiles may be determined by a similar process.

In other embodiments, the processing surface of a microfluidic probe may have different shapes in different regions, for example to create flow velocity profiles with steps of uniform flow velocity gradients instead of a uniform velocity gradient on the entire surface or gradual changes. This is particularly interesting for addressing groups of spots in microarrays that may require different flow conditions depending on the ligand-receptor affinity of the spots.

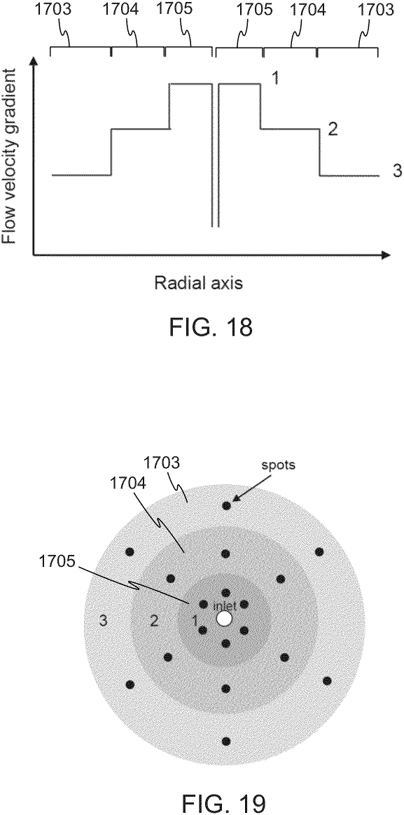

FIG. 17 illustrates a cross section of a microfluidic probe 1701 having a processing surface 1702 with discontinuities of taper between different annular regions 1703, 1704, 1705, in accordance with embodiments of the invention. Microfluidic probe 1701 may produce a flow velocity gradient profile as in FIG. 18, including three regions of different constant flow velocity gradients, respectively in the annular regions 1703, 1704, 1705.

FIG. 19 shows a top view of an area processed by microfluidic probe 1701, including concentric annulus area 1703, 1704, and 1705, having internal constant flow velocity gradients, higher in magnitude closer to the inlet. Spots of a microarray can be distributed radially to obtain similar flow conditions when in a same area. The sizes and number of steps will only be limited by fabrication capabilities. Height changes, particularly > 3 mm away from the inlet, may be very small, for example as small as a few microns.

A processing surface having a tapered geometry may have the additional advantage that it may facilitate filling the system from a dry state to a liquid-filled state. A filling step is necessary in a microfluidic device, when the first liquid fills and wets the entire inner geometry. In such a procedure it is important to ensure stability and performance that no air bubbles/pockets are formed in the process if possible. A tapered geometry helps in first filling all areas of equivalent height, before being pushed into lower areas (symmetrical filling). This is due to the radius of the liquid-air interface, as a higher radius minimizes system energy.

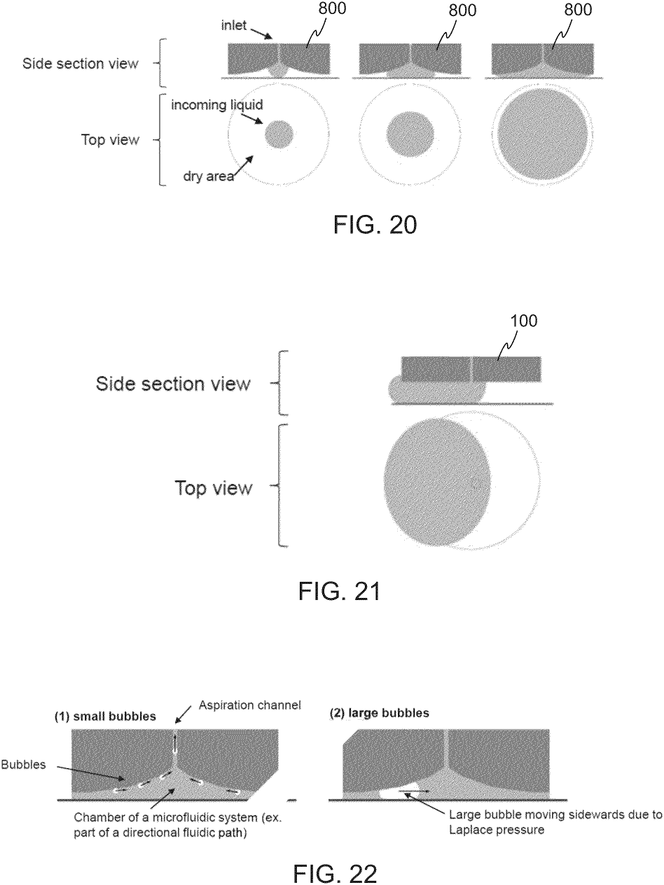

For example, FIG. 20 shows section and top views of a microfluidic probe such as microfluidic probe 800 being used to initially wet a surface, in accordance with embodiments of the invention. The incoming liquid fills the gap below the tapered geometry keeping a generally circular horizontal profile centered in the inlet. No areas remain non-wet at the end of the process.

This is in contrast to the performance of a microfluidic probe such as microfluidic probe 100, having a constant gap height, as shown in FIG. 21. With a constant height, the liquid tends to choose a preferential direction, leading to inhomogeneous filling (air pockets in unfilled areas) and non-radial flows. For the air-liquid interface of the incoming reagent, all directions offer the same energy variation. The liquid filling will then be very sensitive to small changes in surface rugosity and can easily leave non-wet areas, i.e. bubbles.

The presence of bubbles is generally disruptive in any microfluidic system, and may cause undesirable effects such as clogging, disruption of the flow path, and unstable localization. The presence and creation of bubbles is often challenging to avoid depending on the experimental conditions. For example bubble formation may be favored by high temperatures, certain surfactants, high pressure differences, imperfect sealing, or other factors.

Tapered geometries may be used to collect bubbles through an upper aspiration channel, for bubble removal. For example, as is shown in FIG. 22, small bubbles tend to move upwards in such systems because of the slope combined with buoyance effects, and large bubbles tend to displace towards the center of the tapered geometry to minimize liquid-air surface energy (Laplace pressure).

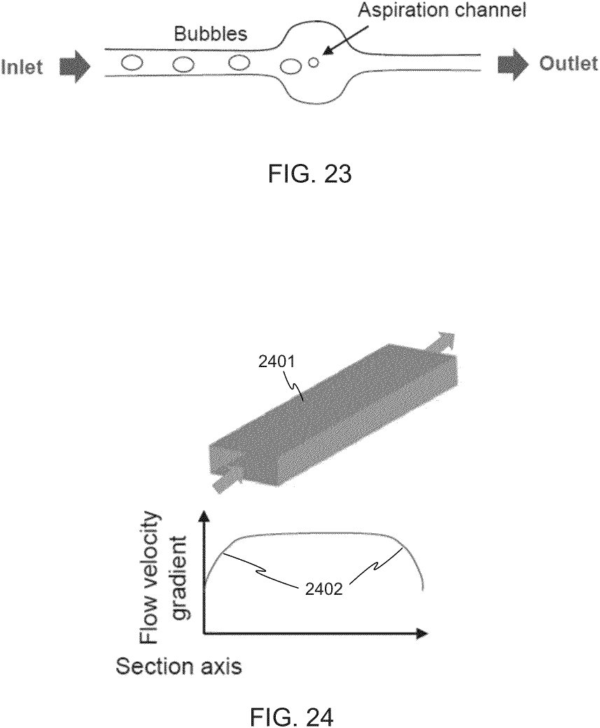

FIG. 23 illustrates the effect of tapered geometry combined with a channel path of a microfluidic device, in accordance with embodiments of the invention. The incoming bubbles are collected by the aspiration channel, resulting in a bubble-free outlet. The aspiration channel can actively aspirate or be static, collecting bubbles by filling a cavity on the top. In vertical inlets or outlets of liquid, for example an outlet of a microfluidic chip or aspiration of a microfluidic probe, a tapered geometry can serve to collect the bubbles formed locally or carried by the liquid. It can also serve to ensure the absence of bubbles from an area of a microfluidic chamber.

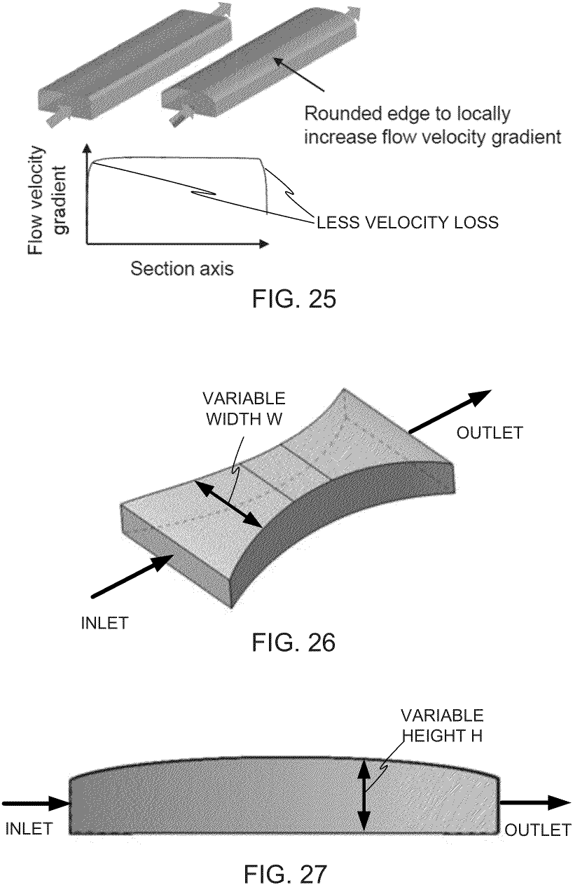

In other embodiments, the principles of tapered geometry may be used in non-radial microfluidic geometries. For example, as shown in FIG. 24, in a straight, closed flow channel 2401 having a rectangular cross section and longitudinal symmetry, the velocity flow gradient tends to decrease close to the side walls. This decrease in flow velocity gradient is shown at 2402. According to embodiments of the invention, the corners of the flow channel may be rounded, as shown in FIG. 25, to reduce the velocity gradient losses.

A similar technique may be used with a flow channel that varies in width, such as channel 2601 shown in FIG. 26. A decrease in section width W will lead to a local increase in the flow velocity gradients. This effect may be compensated by varying the height of the flow channel 2601, as shown in side view in FIG. 27. A gradual decrease in section width can be compensated with a gradual increase in height. Rounded edges (as above) may be used for an improved flow velocity gradient profile across the entire surface.

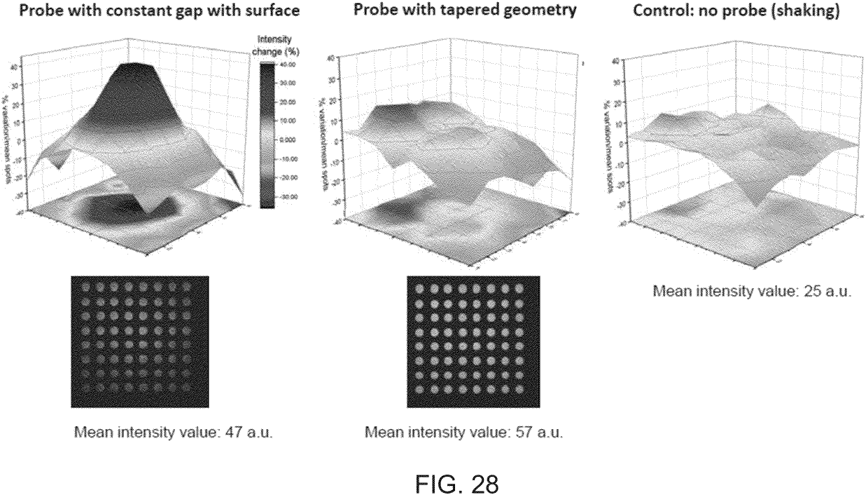

FIG. 28 illustrates experimental results, comparing the performance of a microfluidic probe having a constant gap, such as microfluidic probe 100, with the performance of a microfluidic probe having tapered geometry, such as microfluidic probe 800. A processing solution of anti-IgM at a concentration of 1 µg/mL, was washed over a surface spotted with appropriate antibodies, and a rate of 1 µL/min. The capture rate was measured at the end of the run, by measuring light emanating from each of the spots. As is apparent in the left panel of FIG. 28, the constant-gap probe resulted in a wide range of capture effectiveness, with strong signal in the center of the probed area, but dramatically weaker signal at the periphery of the probed area. The spot array is shown at the bottom of the panel, with the lightness of the spots indicating capture effectiveness. The intensities in FIG. 28 are given in arbitrary units, but are consistent across the three panels.

As shown in the middle panel of FIG. 28, the probe with tapered geometry resulted in much more uniform capture effectiveness, and a higher overall mean capture.

For comparison, the right panel of FIG. 28 shows the results of an experiment where the processing solution was simply washed over the spotted surface and agitated by shaking, without the use of a probe. While the uniformity of capture is good, the overall mean capture effectiveness is much lower than was achieved with either of the two probes, and is less than half that achieved by the probe having tapered geometry. Thus the probe with tapered geometry outperforms a constant-gap probe and outperforms simple washing.

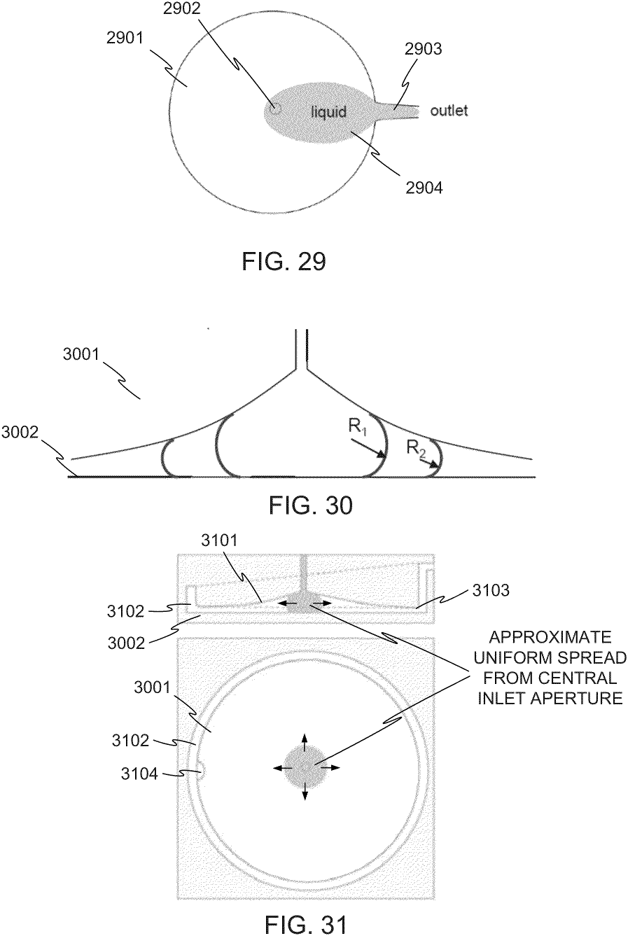

A microfluidic probe having tapered geometry, for example microfluidic probe 800, may also improve the filling of a microfluidic device from a dry state. In order to work properly, the channels of a microfluidic device need to be first entirely filled with liquid. Any pocket of air due to imperfect filling may lead to disrupted hydrodynamic flows and eventual air bubble formation. Microfluidic flat chambers having high aspect ratios with an out of plane injection and a lateral aspiration are particularly difficult to fill from a dry state, for example for radial flows. FIG. 29 illustrates this problem, showing a bottom view of a microfluidic probe 2901 having a central injection aperture 2902 and a side aspiration aperture 2903. Microfluidic probe 2901 may be similar to microfluidic probe 100 described above, having a constant gap to the surface onto which liquid is being dispensed.

Entering liquid 2904 is not compelled to fill such a gap, as it requires its spreading in a very energetically unfavorable way. Instead, the liquid 2904 finds a path of least resistance between inlet 2902 and outlet 2903, leaving most of the geometry non-wet. Large chambers are commonly necessary for biological applications, for example for bioassays between surface receptors such as patterned in spots and molecules in the working liquid.

FIG. 30 illustrates how a microfluidic probe 3001 having tapered geometry may facilitate filling a probe gap from a dry state, particularly on a hydrophobic surface of a plate 3002, for example a surface made of plastic, in accordance with embodiments of the invention. A larger radius of the flow front is more energetically favorable, so that the liquid front will tend to keep a uniform distance from the inlet to minimize its overall curvature.

FIG. 31 shows this effect in top and side views, and also shows additional features that may be present in embodiments of the invention, for further improving filling of the gap from a dry state. For example, processing surface 3101 is surrounded by an annular aspiration groove 3102. Aspiration groove 3102 has generally sharp corners with processing surface 3101, as shown at 3103. However, a notch 3104 is formed at one location in aspiration groove 3102, the purpose of which is described below.

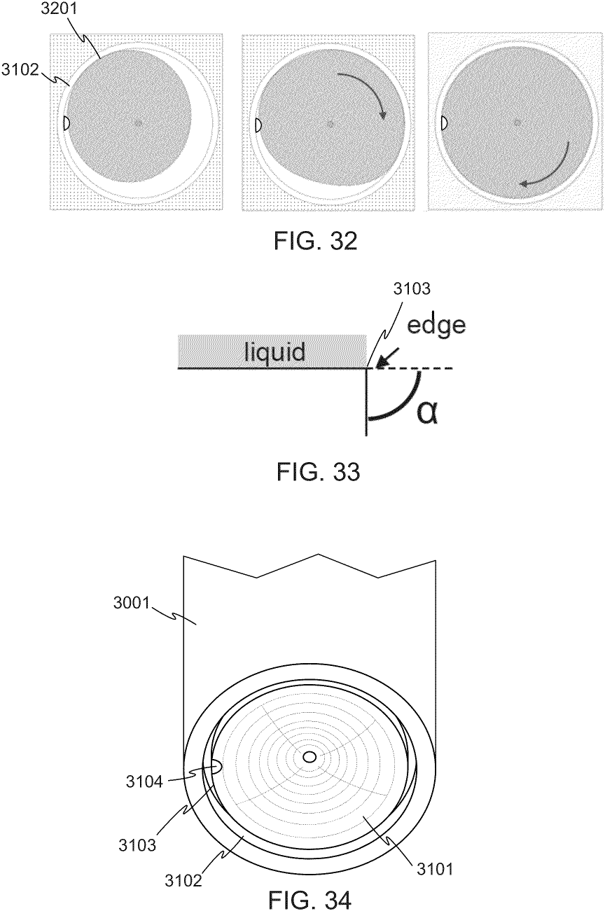

The relatively sharp edges 3103 tend to “pin” the flowing fluid at the edge of the chamber formed between processing surface 3101 and plate 3002. FIG. 32 illustrates this pinning effect, which is due to capillary forces.

In the left panel of FIG. 32, the inflowing fluid has reached the edge of aspiration groove 3102. The capillary forces arising at the sharp edge then to force the fluid to fill other parts of the cavity, as shown in the two right panels of FIG. 32, rather than entering aspiration groove 3102.

FIG. 33 illustrates the effect of capillary forces at edge 3103. Once the liquid front reaches the chamber edge 3103, an abrupt change in height pins the liquid by preventing the advancing movement of the liquid. When the liquid front reaches the edge on one side of the chamber it will stop advancing at that location. This facilitates complete filling of the chamber, as shown in FIG. 32. The pinning effect is obtained with any sharp edge, for example with an angle α between 20 and 160 degrees.

However, the pinning effect is less stable at lower angles. This fact can be exploited to choose where the fluid does eventually overflow the chamber. For example, FIG. 34 shows a lower perspective view of microfluidic probe 3001, including tapered processing surface 3101, aspiration groove 3102, and notch 3104 in edge 3103, in accordance with embodiments of the invention. Notch 3104 is formed by a cylindrical surface having its axis angled 45 degrees from processing surface 3101.

FIG. 35 shows a cross section of microfluidic probe 3001, in accordance with embodiments of the invention. Because notch 3104 is less steeply angled with respect to processing surface 3101 than the rest of edge 3103 of aspiration groove 3102, the incoming fluid will tend to spill from the cavity first thorough notch 3104. While notch 3104 is angled at 45 degrees from processing surface 3101, other angles may be used, but preferably at least 20 degrees.

Also visible in FIG. 35 is the fact that aspiration groove 3102 is not of uniform depth in relation to processing surface 3101. (“Depth” is upward in FIG. 35.) At notch 3104, aspiration groove 3102 is at its minimum depth, and extends only a short distance upward from processing surface 3101. However, opposite notch 3104, aspiration groove 3102 is at its maximum depth, and connects to an outlet port 3501. The depth of aspiration groove 3102 increases with distance from notch 3104 toward outlet port 3501.

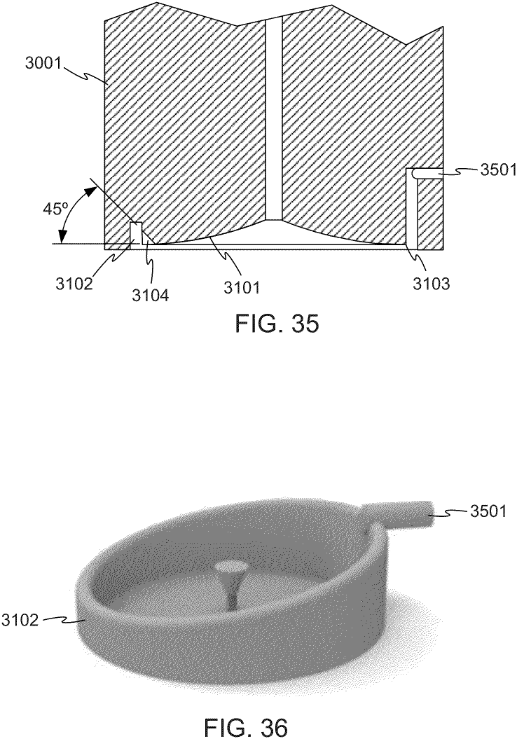

FIG. 36 shows a solid model of the spaces within microfluidic probe 3001 for receiving fluids, or the “negative” of microfluidic probe 3001 itself. This groove configuration helps ensure uniform filling of aspiration groove 3102, without bubble entrapment.

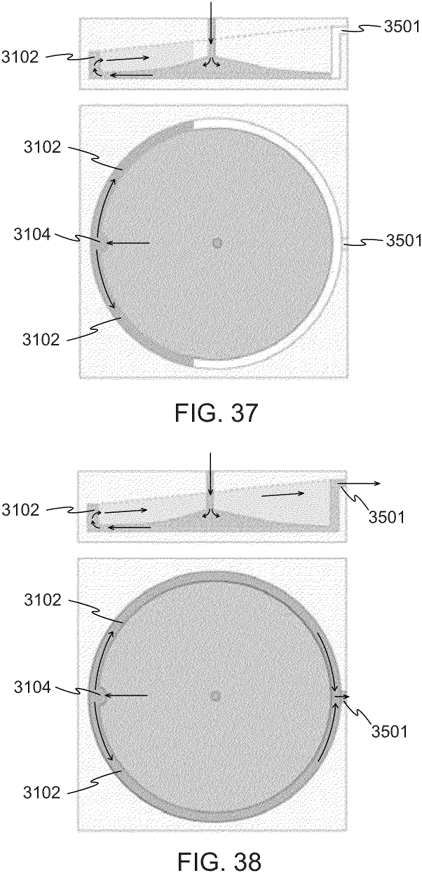

For example, FIGS. 37 and 38 show the filling of aspiration groove 3102. FIG. 37 shows side and top views as the fluid has overflowed notch 3104 and partially filled aspiration groove 3102, in accordance with embodiments of the invention. FIG. 38 shows side and top views as the fluid once aspiration groove 3102 is completely filled. From the point of overflowing notch 3104 the liquid front moves towards outlet 3501 on either side of the chamber. The liquid overflows over the edge as its front advances inside the groove 3102. An increasing height of the groove 3102 towards the outlet 3501 ensures that the fronts at both sides moves forward with similar speeds and meet at the outlet 3501. The groove 3102 will serve as a source of homogeneous aspiration to obtain radial flows in the chamber. The depth of the chamber may range between 0.5 and 10 mm, with a ceiling angle between 2 and 60 degrees, although other dimensions and angles are possible.

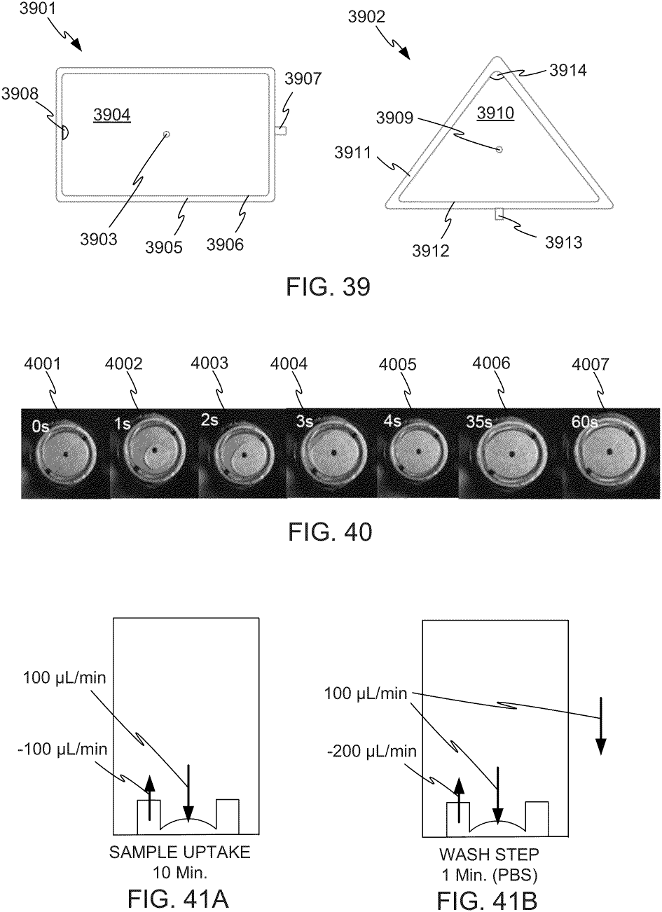

While the microfluidic probes described above are circular, aspects of the invention may be embodied in probes of other shapes as well. For example, FIG. 39 shows bottom views of a rectangular probe 3901 and a triangular probe 3902, in accordance with embodiments of the invention. Rectangular probe 3901 includes an inlet aperture 3903, a tapered processing surface 3904, an aspiration groove 3905, a pinning edge 3906, an outlet aperture 3907, and an overflow notch 3908. Similarly, triangular probe 3902 includes an inlet aperture 3909, a tapered processing surface 3910, an aspiration groove 3911, a pinning edge 3912, an outlet aperture 3913, and an overflow notch 3914.

FIG. 40 shows the filling of the chamber from initial dry state 4001 in an experimental result, in accordance with embodiments of the invention. The views in FIG. 40 are from the bottom of a plate onto which liquid is being dispensed. At state 4002, liquid has started to flow and spread from the central aperture. At state 4003, the liquid has reached the pinning edge of the processing surface, and has started to flow outward from the pinned location around the perimeter of the processing surface. At state 4004, the fluid has nearly completely wetted the surface. At state 4005, the plate is completely wetted beneath the processing surface. In states 4006 and 4007, the liquid spills into the aspiration groove surrounding the processing surface, and is aspirated away.

Experiments have shown that low flow rates, for example 10 µl/min, through a microfluidic probe may not result in homogeneous filling of the gap between the processing surface and the plate. However, low flow rates may be desirable in some cases, for example to minimize the shear stress on red blood cells, which could lead to sample hemolysis.

In some applications, sample injection may be performed in two stages – a first stage having a high flow rate, and a second stage having a low flow rate. For example, to inject 80 µl of sample, the first 20 µl may be injected at 100 µl/min, and the remaining 60 µl injected at rate of 10 µl/min. Other flow rates may be used as well. This two-stage process may result in more homogeneous filling of the gap between the processing surface and the plate.

### Screening or Identification of Atypical Anti-Erythrocyte Antibodies

Embodiments of the invention may be used, for example, for screening or identification of atypical anti-erythrocyte antibodies. For example, embodiments of the invention may be used to detect the presence or absence, in an individual’s blood, of antibodies directed against various erythrocyte antigens. For this, it is sought to demonstrate the binding of these antibodies (IgG and/or IgM) to phenotyped red blood cells, the antigens of which are known or/and to recombinant antigens. When bound on phenotyped red blood cells or recombinant antigens, these atypical anti-erythrocyte antibodies are revealed by an anti-immunoglobulin antibody. In a first step, use is made of a panel of “screening” red blood cells (two or three red blood cells of different groups chosen so as to carry all the antigens of importance in transfusion for detecting the presence or absence of atypical antibodies). In case of positive screening, the specificity of the atypical antibody or antibodies present is then identified by means of at least one panel of “identifying” red blood cells. In general, 10 to 15, or even 20, different red blood cells phenotyped in the vast majority of the known blood group systems are used.

The surface of the substrate is used to immobilize native or hemolyzed phenotyped red blood cells via poly-D-lysine (PDL). For this application, the microfluidic probe is designed to perform the sequential chemistry: deposit of patient plasma, serum or whole blood sample, removal of unspecific antibodies by washing with buffer solution and dispense of labeled anti-Fc antibody conjugate to detect bound antibodies. To increase the sensitivity, the one-step revelation can be replaced by a 2-step revelation: dispense of biotin labeled anti-Fc antibody conjugate (biotinylated AHG), removal of the unbound excess, dispense of a phosphatase alkaline labeled streptavidin (SA-PAL), removal of the excess, and addition of the substrate.

In an example method, the surface of the substrate is a polystyrene 96-wells flat bottom plates. A 10 µg/ml of PDL in PBS, pH 7.4 is dispensed into each well and incubated for 2 hours at room temperature. At the end of this step, the wells are washed in PBS pH 7.4, then in water. Finally, they are dried and then used to immobilize the cells.

The binding agents are native phenotyped red blood cells. Cells are deposited with a non-contact printer as spots on the PDL-coated well bottoms. In this example, 10% cell suspensions in physiological water are used. After deposition, the substrate is washed to remove unbound cells and then saturated by contact with physiological water supplemented with PVA/BSA 10 g/L to prevent non-specific binding of sample components and cells preservation. Then, the surface is dried.

Each red blood cell is spotted in several replicate to guarantee the reproducibility of the results. Here, two phenotyped red blood cells were immobilized; they were chosen in order that one cell was positive for the expression of a particular antigen whereas the second one is negative. The evaluated antigens belong to the main systems (Rhesus, Kidd, Duffy, MNSs, Kell). A grid of 64 spots (32 spots of one RBC and 32 of the other one) was spotted.

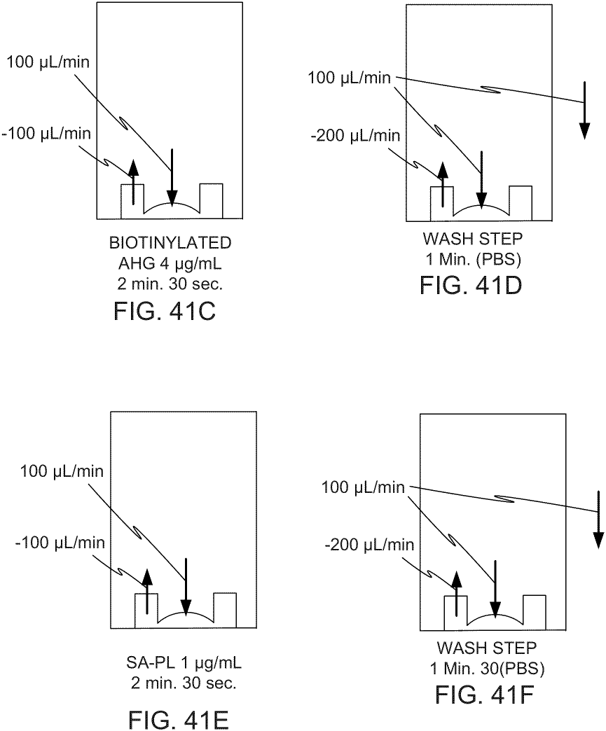

Further steps in the method are as follows, with reference to FIGS. 41A-41F:

A microfluidic probe is positioned in the dried well. The probe may be, for example, of any of the types described above. The patient plasma, serum or whole blood, is flowed over the well to bring the sample and RBCs into contact. The injection flow performed with the central channel is done at 100 µL/min and simultaneously the solution is aspirated at the same flow rate by the grooves. This incubation step lasts about 10 minutes, as illustrated in FIG. 41A, and is followed by a washing step, as illustrated in FIG. 41B. To ensure that all sample’s traces are completely removed, PBS buffer is injected through the central channel (100 µL/min) but also through the immersion liquid channel (100 µL/min), and this buffer is immediately aspirated by the grooves at 200 µL/min. Performing this step for about one minute may be sufficient to remove all the unspecific antibodies, but other time periods may be used. Then, the biotin labeled anti-Fc antibody conjugate at 4 µg/ml diluted in PBS/BSA is deposited from the central channel at 100 µL/min and simultaneously aspirated at the same speed by the groove, as shown in FIG. 41C. This step may last about 2.5 minutes, or another appropriate time. Potential excess of conjugate is removed by PBS buffer dispensed from the central channel as well as the immersion liquid channel, buffer aspirated by the grooves at 200 µL/min. This washing step may also last about one minute, or another suitable time, as shown in FIG. 41D. To complete the revelation, the phosphatase alkaline labeled streptavidin diluted at 1 µg/mL in PBS/BSA is injected by the central channel at 100 µL/min and aspirated by the grooves at the same speed, as shown in FIG. 41E. This step may also last for about 2.5 minutes. At the end, a final washing to remove unbound labeled streptavidin is performed for about one minute by injecting TBS buffer from the central and liquid immersion channels at 100 µL/min, and aspirating by the grooves at 200 µL/min, as shown in FIG. 41F. The addition of a precipitating substrate allows to detect the presence or absence of antibodies attached to the red blood cells by colorimetry. All these sequential steps are preferably performed with the head at 37° C.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents. It is to be understood that any workable combination of the features and capabilities disclosed herein is also considered to be disclosed.

What is claimed is:

1. A microfluidic probe head, comprising:
a body having a proximal end and a distal end;
a processing surface at the distal end; and
an injection aperture in the processing surface;
wherein the processing surface is non-planar.

2. The microfluidic probe head of claim 1, wherein the processing surface is recessed from the distal end at the injection aperture.

3. The microfluidic probe head of claim 2, wherein a distance from the processing surface to the distal end diminishes with radial distance from the injection aperture.

4. The microfluidic probe head of claim 3, wherein a cross section profile of the processing surface is curved, and has its concave side disposed toward the proximal end.

5. The microfluidic probe head of claim 4, wherein the cross section profile of the processing surface is selected to create a constant velocity gradient as a function of radial distance of fluid flowing from the injection aperture onto a test surface near the distal end.

6. The microfluidic probe head of claim 4, wherein the injection aperture is recessed from the distal end by a distance Hᵢ, and the injection aperture is circular with a radius Rᵢ, and wherein as a function of radial distance r, the processing surface is recessed from the distal end by a distance
$$H = {H}_{i} \sqrt{\frac{{r}_{i}}{r}} .$$
.

7. The microfluidic probe head of claim 4, wherein the cross section profile of the processing surface is selected to create a linearly decreasing velocity gradient as a function of radial distance of fluid flowing from the injection aperture onto a test surface near the distal end.

8. The microfluidic probe head of claim 3, wherein the processing surface has discontinuities of taper between different annular regions of the processing surface.

9. The microfluidic probe head of claim 1, further comprising one or more spacing features extending distally of the processing surface, for spacing the processing surface from a plate when the one or more spacing features are placed against the test surface.

10. The microfluidic probe head of claim 9, wherein the one or more spacing features comprise a raised perimeter at the distal end.

11. The microfluidic probe head of claim 9, wherein the one or more spacing features comprise a plurality of aspiration posts.

12. The microfluidic probe head of claim 1, further comprising one or more aspiration apertures in the body, in fluid communication with the injection aperture when the distal end is placed against a test surface.

13. The microfluidic probe head of claim 12, wherein the one or more aspiration apertures are disposed in a groove at the perimeter of the processing surface.

14. The microfluidic probe head of claim 12, wherein the one or more aspiration apertures are disposed in the processing surface.

15. The microfluidic probe head of claim 1, further comprising an aspiration groove surrounding the processing surface.

16. The microfluidic probe head of claim 15, wherein an overflow notch is defined in a perimeter edge of the processing surface.

17. The microfluidic probe head of claim 16, wherein the aspiration groove is variable in depth, and has its minimum depth at a location proximate the overflow notch, and has its maximum depth at a location opposite the overflow notch.

18. The microfluidic probe head of claim 1, wherein the microfluidic probe head is non-circular.

19. A method, comprising:
injecting a first quantity of fluid onto a surface through a microfluidic probe at a first flow rate; and
injecting a second quantity of fluid onto the surface through the microfluidic probe at a second flow rate.

20. The method of claim 19, wherein the first flow rate is higher than the second flow rate.
